(19) United States
(12) Patent Application Publication
(10) Pub. No.: US 2025/0312771 A1
(43) Pub. Date: Oct. 9, 2025

(54) METHOD FOR HYDROTHERMAL CARBONIZATION AND ACTIVATION OF CARBON DIOXIDE CAPTURE MATERIALS

(71) Applicant: University of South Carolina, Columbia, SC (US)

(72) Inventors: Jochen A. Lauterbach, Columbia, SC (US); Sarah L. Stofik, Quakertown, PA (US); Alexis Allegro, Colts Neck, NJ (US); Alyssa Brucato, Westwood, MA (US); Trevor Corsello, Columbia, SC (US); Victoria Garman, Summerville, SC (US); Jennifer K. Naglic, Columbia, SC (US); Kaveh Shariati, West Columbia, SC (US); Samuel Drummond, Columbia, SC (US); Thossaporn Onsree, Columbia, SC (US); Sanphawat Phromphithak, Chiang Mai (TH)

(73) Assignee: University of South Carolina, Columbia, SC (US)

(21) Appl. No.: 19/092,918

(22) Filed: Mar. 27, 2025

Related U.S. Application Data
(60) Provisional application No. 63/575,330, filed on Apr. 5, 2024.
(60) Provisional application No. 63/707,566, filed on Oct. 15, 2024.

(51) Int. Cl. B01J 20/30; B01D 53/04; B01J 20/20; B01J 20/34

(52) U.S. Cl. CPC B01J 20/3085; B01D 53/04; B01J 20/20; B01J 20/3071; B01J 20/3078; B01J 20/3483; B01D 2253/102; B01D 2257/504; B01D 2259/40098

(57) ABSTRACT

A carbon capture and storage (CCS) material may be synthesized using a wide variety of feedstock from agricultural, forestry, and sanitary wastes. The feedstock is heated under a reaction medium. After adding a solution of an activating alkali metal compound to the feedstock, the feedstock and activating alkali metal compound are heated under flowing gases to form the CCS material. This CCS material may be used and regenerated multiple times, then used as a soil amendment.

### CROSS-REFERENCE TO RELATED APPLICATIONS

This application claims the benefit of prior-filed, co-pending U.S. Provisional Patent Applications Nos. 63/575,330 and 63/707,566, filed on Apr. 5, 2024 and Oct. 15, 2024, respectively, the contents of which are incorporated herein by reference in their entirety.

### BACKGROUND OF THE INVENTION

Greenhouse gas emissions have many negative consequences. Human activities, mainly burning fossil fuels, have increased atmospheric greenhouse gas concentrations. Carbon dioxide (CO₂) is one of the most abundant greenhouse gases released into the atmosphere. Even though natural processes such as respiration and photosynthesis maintain the carbon dioxide level in the Earth's atmosphere through the carbon cycle, the atmospheric carbon dioxide level is considerably increasing. The atmospheric carbon dioxide concentration increased from 280 ppm before the industrialization era to 401 ppm in 2015, and it is projected to reach 570 ppm by the year 2100. This rise in carbon dioxide levels has contributed to global warming, leading to various impacts such as an increase in global sea levels, increasingly violent weather patterns, and altered ranges for wild animals. The substantial increase in carbon dioxide levels has prompted the development of strategies to reduce carbon dioxide emissions. The Kyoto Protocol introduced carbon capture and storage (CCS) techniques as a proposed solution to mitigate carbon dioxide emissions effectively. However, one of the primary challenges in the CCS process is the expensive carbon dioxide capture phase. Carbon-based adsorbents are widely recognized for their large surface area, porous structure that can be modified, and ease of regeneration. They have been proven highly effective materials for capturing and sequestering carbon dioxide, making them attractive choices for this purpose. However, current CCS adsorbents use mostly synthetic materials that are created for direct air capture. The adsorbent synthesis process uses expensive chemicals, creates waste, and is energy intensive.

Common agricultural crops throughout the world generate significant biomass residues after harvest, making them widely available and inexpensive. The burning of such biomass residues in open air can cause numerous air pollution issues. In Thailand, for example, agricultural residues produced from major crops such as corn, sugarcane, cassava, rice, and palm amount to around 174.1 million tons annually. Burning these biomass residues leads to the emission of substantial amounts of carbon dioxide and particulate matter (PM). In the emission inventory of PM10, biomass burning accounted for a significant portion of approximately 40%. The observed PM concentrations include a range of particles from PM10 to PM2.5, which are directly emitted from biomass combustion and affect the atmosphere, both directly and indirectly impacting atmospheric radiation. The direct effects involve the absorption and scattering of solar radiation, influencing global climate change, while indirect ways result from the accumulation of cloud condensation nuclei, leading to increased cloud albedo. Moreover, the PM from biomass burning can also have severe consequences for human health, including cardiovascular morbidity, respiratory symptoms, and adult mortality, especially in high-risk groups. Alternatively, utilizing these biomass residues as a feedstock for carbon-based adsorbents (also known as biochar) offers several advantages, such as low production cost, near-universal availability, sustainable adsorbents, and mitigation of air pollutant emissions.

In general, agricultural residues are considered as lignocellulosic biomass, composed of three main components: cellulose (40-80%), hemicellulose (15-30%), and lignin (10-25%). Lignin serves as a binding agent that holds the carbohydrate components (cellulose and hemicellulose) together. It presents a barrier to converting biomass into biofuels and biochemicals. Therefore, delignification and fractionation of lignocellulosic biomass are essential for increasing the efficiency of biochar production. Due to the complexity of the various components of the biomass, multiple pretreatment steps are generally required to produce the final biochar. Biomass pretreatment with ionic liquids is highly efficient for restructuring lignocellulosic biomass. Ionic liquid pretreatment of biomass involves breaking the β-O-4 bonds within lignin subunits, breaking down ester and ether linkages between lignin and carbohydrates, and disrupting hydrogen bonds among polysaccharide chains. After the process, the pretreated biomass is less rigid and complex, which increases the carbohydrate accessibility of the biomass. Although the effectiveness of ionic liquid pretreatment is excellent, the prohibitive cost is a significant economic concern.

It is therefore the object of this application to provide cost-effective and efficient carbon dioxide adsorption materials for practical implementation.

### BRIEF SUMMARY OF THE INVENTION

The present application is for a method for synthesizing a carbon capture and storage (CCS) material. The method heats a feedstock under a reaction medium, adds a solution of an activating alkali metal compound to the feedstock, and heats the feedstock and activating alkali metal compound under flowing gases to form the CCS material.

The activation temperature for heating the feedstock and activating alkali metal compound may range from 180° C. and 900° C.

The feedstock and the activating alkali metal compound may be heated in a reaction medium selected from the group consisting of: water, molecular oxygen, molecular nitrogen, carbon dioxide, argon, and any combination thereof.

The alkali metal compound may be an alkali hydroxide compound. The alkali metal compound may be potassium hydroxide.

Heating the feedstock and the activating alkali metal compound under the reaction medium may comprise hydrothermal processing. Adding the solution of the activating alkali metal compound to the feedstock may comprise mixing the feedstock with deionized water at a fixed weight ratio of 1:3 in a sealed Teflon-lined autoclave.

The feedstock may be pretreated with a lignin disrupter before heating. The lignin disrupter may be selected from the group consisting of: glycerol and LTTM. The feedstock may be combined with the lignin disrupter at a fixed fraction of 10% w/w. The feedstock may be filtered after pretreating with the lignin disrupter to separate solid feedstock and liquid products. The feedstock may be dried.

Liquids may be recovered from the heated feedstock.

The CCS material may be washed to remove contaminants. The CCS material may be washed with deionized water followed by acetone.

The CCS material may be dried.

The CCS material may be exposed to carbon dioxide to adsorb and retain the carbon dioxide on the surface of the CCS material.

An amount of CCS material may be heated at a regeneration temperature to desorb carbon dioxide from the surface to regenerate the amount of used CCS material for reuse. The regeneration temperature may range between 50° C. and 200° C. A vacuum may be pulled on the amount of used CCS material during heating to lower the heating requirements.

### BRIEF DESCRIPTION OF THE SEVERAL VIEWS OF THE DRAWING

FIGS. 1a and 1b illustrate a flowchart of an exemplary method for hydrothermal carbonization and activation of carbon dioxide capture materials.

### DETAILED DESCRIPTION OF THE INVENTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Measurements and materials identified in the drawings and applications are by way of example only and are not intended to limit the scope of the claimed invention. Any other measurements and materials not consistent with the purpose of the present application can also be used. Various equivalents, alternatives and modifications are possible within the scope of the appended claims. Each limitation in the appended claims is intended to invoke interpretation under 35 U.S.C. § 112, sixth paragraph, only if the terms “means for” or “step for” are explicitly recited in the respective limitation.

The method 100 for hydrothermal carbonization and activation of carbon dioxide capture materials synthesizes a low-cost waste-carbon-based carbon capture and storage (CCS) material from multiple types of waste biomass feedstock, which may include, by way of non-limiting example, logging residue, agricultural waste, or human or animal biosolids. By using widely available waste, the starting feedstock is inexpensive to acquire. Waste biomass is a naturally occurring feedstock that would otherwise be left to rot. The synthesis process does not use as harsh chemicals in the abundant amounts of other synthesis processes. Throughout the synthesis process, these starting feedstocks are converted to CCS materials to allow carbon dioxide to be adsorbed on the surface. The CCS material is suitable for direct air capture applications and able to be reused many times by desorbing the carbon dioxide from the surface. At the end of its lifetime, the CCS material can be used as a soil amendment.

One aspect of this method 100 is the potential use of a new class of designable solvents, referred to as low transition temperature mixtures (LTTMs). LTTMs have emerged as a potential solution for delignification and fractionation of lignocellulosic biomass such as, but not limited to, agricultural and logging residues. LTTMs offer several advantages, including affordability, biodegradability, and renewability. Using readily available hydrogen bond acceptors and donors, LTTMs can be synthesized through hydrogen-bond interactions. The properties of LTTMs can be tailored by selecting different combinations of the LTTM components. By way of non-limiting example, the LTTM can be a combination of choline chloride (ChCl) and glycerol. Among various ionic liquids, ChCl has proven efficient, accessible, and cost-effective. It can be mixed with many chemicals to create novel LTTMs. Glycerol, a by-product of biodiesel production, is abundant due to increased global biodiesel demand. Therefore, ChCl and glycerol are attractive choices for chemical feedstocks to synthesize LTTMs because they are non-toxic and biocompatible. In one non-limiting example, the LTTM is a mixture of ChCl and glycerol at the molar ratio of 1:4. Other LTTM components may include aluminum chloride hexahydrate, glucose, xylose, malic acid, tartaric acid, lactic acid, and citric acid.

As part of the conversion process, the feedstock may be heated under various conditions to convert the biomass. Different feedstocks may utilize different heating processes, varying the reaction medium and temperature. Hydrothermal processing takes place at approximately 180-350° C. with water acting as the reaction medium. Gasification generally occurs at greater than approximately 700° C. under oxidizing environments. Pyrolysis and torrefaction take place under inert gases or controlled levels of oxygen. Pyrolysis occurs at greater than approximately 400° C., while torrefaction occurs at approximately 200-350° C.

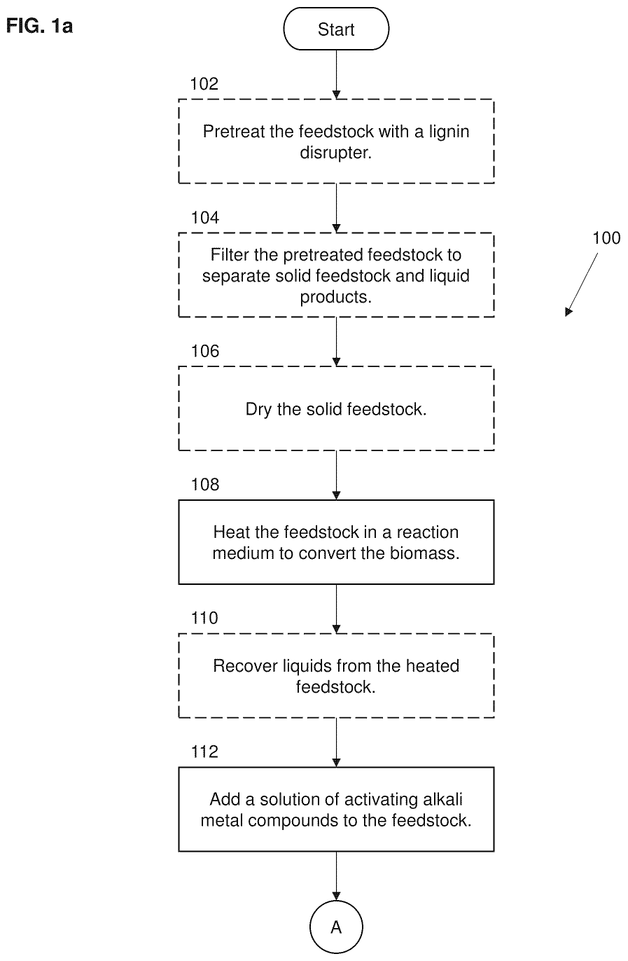

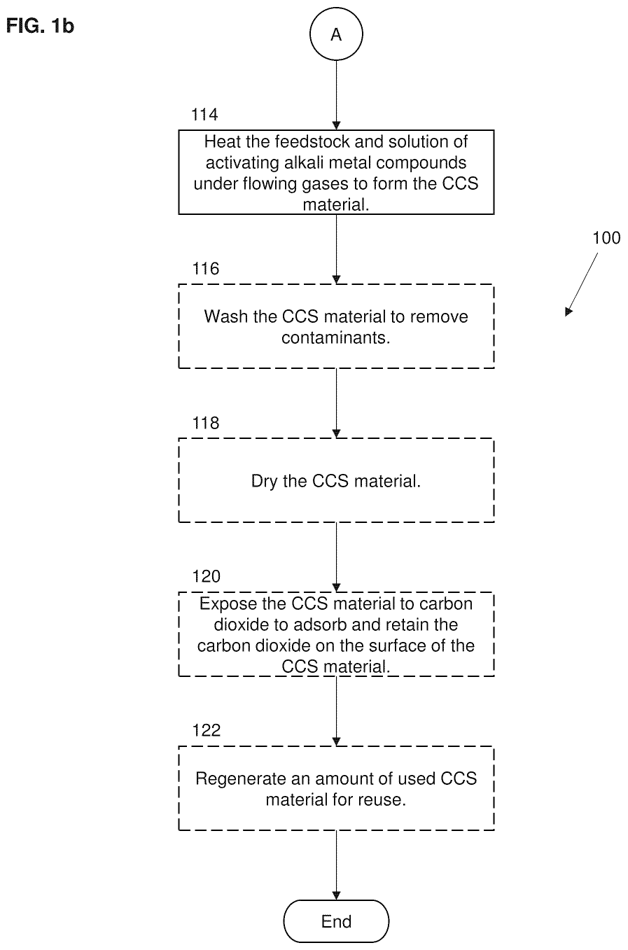

As shown in the flowchart in FIGS. 1a and 1b, the method 100 converts different forms of waste biomass into efficient direct air carbon dioxide capture materials. This allows feedstock flexibility in the capture material, which allows adjustment of feedstocks based on seasonal availability, regional availability, and seasonal competition with other industries. Feedstock can include, but is not limited to, logging residue, agricultural residues, deer corn, human and animal waste biosolids, wheat and other straws, corn and other stalks, wood, alfalfa and beet pulp, cover crops, regenerative crops, and corncobs.

In optional block 102, the method 100 pretreats the feedstock with a lignin disrupter. In various embodiments, the lignin disrupter may be glycerol or LTTM. In one embodiment, the feedstock is combined with the lignin disrupter at a fixed fraction of 10% w/w. In one embodiment, the pretreatment is carried out at 150° C. for 20 hours.

In optional block 104, the method 100 filters the pretreated feedstock to separate solid feedstock and liquid products.

In optional block 106, the method 100 dries the solid feedstock. In one embodiments, the solid feedstock is dried at 110° C. for 24 hours.

In block 108, the method 100 heats the feedstock in a reaction medium to convert the biomass. In certain embodiments, the treatment is selected from: hydrothermal processing, gasification, pyrolysis, or torrefaction. In certain embodiments, the temperature ranges between 180° C. and 900° C. In certain embodiments, the gases are selected from molecular nitrogen, carbon dioxide, and argon. In certain embodiments, the gases are single gases or combinations of gases free from molecular oxygen.

In optional block 110, the method 100 recovers liquids from the heated feedstock. These liquids can be further treated in a separate process and used as biooil. This block may occur simultaneously with the previous block.

In block 112, the method 100 adds a solution of activating alkali metal compounds to the feedstock. In certain embodiments, the feedstock and alkali metal solution are stirred at approximately 70-110° C. until the feedstock dries. In certain embodiments, the alkali metal compound is an alkali hydroxide compound. In certain embodiments, the alkali metal compound is potassium hydroxide. In one embodiment where block 108 included hydrothermal processing, the feedstock is mixed with deionized water at a fixed weight ratio of 1:3 in a sealed Teflon-lined autoclave.

In block 114, the method 100 heats the feedstock and solution of activating alkali metal compounds under flowing gases to form the CCS material. In certain embodiments, the activation temperature ranges between 300° C. and 900° C. In certain embodiments, the gases are selected from molecular nitrogen, carbon dioxide, and argon. In certain embodiments, the gases are single gases or combinations of gases free from molecular oxygen to prevent combustion. In one embodiment, the method 100 heats the CCS material at 900° C. for 2 hours under a 100-mL/min continuous flow of nitrogen gas.

In optional block 116, the method 100 washes the CCS material to remove contaminants. In one embodiment, the CCS material is washed with deionized water followed by acetone.

In optional block 118, the method 100 dries the CCS material.

In optional block 120, the method 100 exposes the CCS material to carbon dioxide to adsorb and retain the carbon dioxide on the surface of the CCS material.

In optional block 122, the method 100 regenerates an amount of used CCS material for reuse. This is accomplished by heating the used CCS material to desorb the carbon dioxide from the surface. In certain embodiments, the regeneration temperature ranges between 50° C. and 200° C. In one embodiment, the regeneration temperature is 110° C. In certain embodiments, a vacuum is pulled on the used CCS material during heating to lower the heating requirements. In one embodiment, the regeneration temperature is 70° C. under vacuum.

It is to be understood that this written description uses examples to disclose the invention, including the best mode, and also to enable any person skilled in the art to make anew the invention. The various embodiments of the invention may be combined in any arrangement capable of producing a CCS material. Any dimensions or other size descriptions are provided for purposes of illustration and are not intended to limit the scope of the claimed invention. Additional embodiments can include variations component composition, synthesis, and combination, as well as variations required for use in the industry. The patentable scope of the invention may include other examples that occur to those skilled in the art.

1. A method for synthesizing a carbon capture and storage (CCS) material, comprising:
heating a feedstock under a reaction medium; and
adding a solution of an activating alkali metal compound to the feedstock; and
heating the feedstock and activating alkali metal compound under flowing gases to form the CCS material.

2. The method of claim 1, wherein the activation temperature for heating the feedstock and activating alkali metal compound ranges from 180° C. and 900° C.

3. The method of claim 1, wherein the feedstock and the activating alkali metal compound are heated in a reaction medium selected from the group consisting of: water, molecular oxygen, molecular nitrogen, carbon dioxide, argon, and any combination thereof.

4. The method of claim 1, wherein the alkali metal compound is an alkali hydroxide compound.

5. The method of claim 4, wherein the alkali metal compound is potassium hydroxide.

6. The method of claim 1, wherein heating the feedstock and the activating alkali metal compound under the reaction medium comprises hydrothermal processing.

7. The method of claim 6, wherein adding the solution of the activating alkali metal compound to the feedstock further comprises mixing the feedstock with deionized water at a fixed weight ratio of 1:3 in a sealed Teflon-lined autoclave.

8. The method of claim 1, further comprising pretreating the feedstock with a lignin disrupter before heating the feedstock.

9. The method of claim 8, wherein the lignin disrupter is selected from the group consisting of: glycerol and LTTM.

10. The method of claim 9, wherein the feedstock is combined with the lignin disrupter at a fixed fraction of 10% w/w.

11. The method of claim 8, further comprising filtering the feedstock after pretreating the feedstock with the lignin disrupter to separate solid feedstock and liquid products.

12. The method of claim 11, further comprising drying the solid feedstock.

13. The method of claim 1, further comprising recovering liquids from the heated feedstock.

14. The method of claim 1, further comprising washing the CCS material to remove contaminants.

15. The method of claim 14, further comprising washing the CCS material with deionized water followed by acetone.

16. The method of claim 1, further comprising drying the CCS material.

17. The method of claim 1, further comprising exposing the CCS material to carbon dioxide to adsorb and retain the carbon dioxide on the surface of the CCS material.

18. The method of claim 1, further comprising heating an amount of used CCS material at a regeneration temperature to desorb carbon dioxide from the surface to regenerate the amount of used CCS material for reuse.

19. The method of claim 18, wherein the regeneration temperature ranges between 50° C. and 200° C.

20. The method of claim 19, wherein a vacuum is pulled on the amount of used CCS material during heating to lower the heating requirements.
